(19) United States
(12) Patent Application Publication
(10) Pub. No.: US 2006/0179889 A1
(43) Pub. Date: Aug. 17, 2006

(54) Method for dehydrating and consolidating a porous optical fiber preform

(75) Inventors: Young-Sik Yoon, Chilgok-gun (KR); Mun-Hyun Do, Chilgok-gun (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/332,757

(22) Filed: Jan. 13, 2006

(30) Foreign Application Priority Data
Feb. 17, 2005 (KR) 2005-13135

(51) Int. Cl. C03B 37/07; C03B 37/018

(52) U.S. Cl. 65/384; 65/426; 65/427

(57) ABSTRACT

A method for dehydrating and consolidating a porous optical fiber preform in a heating apparatus is provided. The apparatus includes a muffle in which the porous optical fiber preform is placed and a plurality of multi-stage heaters attached to an outer circumference of the muffle in a longitudinal direction of the preform. The preform is placed in the muffle such that the multi-stage heaters surround a total length of the preform. The preform is heated and dehydrated in a state in which a temperature of the multi-stage heaters reaches a dehydrating temperature of the preform. A temperature of one heater selected from the heaters is raised to a consolidating temperature of the preform. The dehydrated preform is moved and is passed through a high temperature zone formed by the selected heater in the muffle. The dehydrated preform is consolidated.

### CLAIM OF PRIORITY

This application claims priority under 35 U.S.C. § 119 to an application entitled “Method for Dehydrating and Consolidating a Porous Optical Fiber Preform,” filed in the Korean Intellectual Property Office on Feb. 17, 2005 and assigned Serial No. 2005-13135, the contents of which are incorporated herein by reference.

### BACKGROUND OF THE INVENTION

1. Field of the Invention

The present invention generally relates to a method of heating an optical fiber preform, and more particularly to a method of dehydrating and consolidating a porous optical fiber preform.

2. Description of the Related Art

Conventionally, a porous optical fiber preform manufactured by a vapor axial deposition (VAD) or outside vapor deposition (OVD) process is dehydrated and consolidated, such that the consolidated optical fiber preform can be obtained. The optical fiber preform is heated under the atmospheric gas, such as Cl₂, He, or so on.

FIG. 1 illustrates a conventional apparatus for dehydrating and consolidating a porous optical fiber preform. The apparatus 100 is provided with a muffle 110 and a heater 120.

The porous optical fiber preform 130 is supported by a handle rod 140, and may or may not include a starting rod.

The muffle 110 is provided with a hole that is formed on the top thereof and passes through the handle rod 140, an outlet tube 114 formed on the upper part thereof, and an inlet tube 112 formed on the lower part thereof. Atmospheric gas 150 is supplied into the muffle 110 through the inlet tube 112. The atmospheric gas 150 is exhausted to outside through the outlet tube 114. The porous optical fiber preform 130 is placed within the muffle 110.

The heater 120 is attached to the outer circumference of the muffle 110 and has a ring shape.

A method for dehydrating and consolidating the porous optical fiber preform using the apparatus 100 includes the following processes (a)˜(g):

(a) The porous optical fiber preform 130 is placed within the muffle 110. At this time, the lower part of the porous optical fiber preform 130 is placed near the heater 120.

(b) The atmospheric gas 150 is supplied into the muffle 110 through the inlet tube 112.

(c) The heater 120 forms a high temperature zone corresponding to a dehydrating temperature (1000˜1200° C.) of the porous optical fiber preform 130 in the muffle 110.

(d) The porous optical fiber preform 130 is moved in a downward direction such that the total length of the porous optical fiber preform 130 can pass through the high temperature zone.

(e) The porous optical fiber preform 130 dehydrated in the process (d) is moved in an upward direction such that it can return to the original position (i.e., a position for the process (a)).

(f) The heater 120 forms a high temperature zone corresponding to a consolidating temperature (1500˜1600° C.) of the porous optical fiber preform 130 in the muffle 110.

(g) The dehydrated porous optical fiber preform 130 is moved in the downward direction so that the total length of the dehydrated porous optical fiber preform 130 can pass through the high temperature zone.

The conventional method of dehydrating and consolidating the porous optical fiber preform is based on a zone heating process, which has an advantage in that bubble removal and densification are less complex, and a consolidated optical fiber preform of high purity can be obtained. However, a porous optical fiber preform must be moved in a downward direction at least two times such that the dehydration and consolidation processes can be performed. However, there is a problem in that such method requires a lengthy process due to a high temperature zone of a relatively short length (in a longitudinal direction of the porous optical fiber preform) when a large diameter porous optical fiber preform with a diameter of more than 200 mm and a length of more than 1500 mm is applied.

### SUMMARY OF THE INVENTION

The present invention has been designed to solve the above and other problems occurring in the prior art and further provides additional advantages, by providing a method for dehydrating and consolidating a porous optical fiber preform that can be applied to a large diameter porous optical fiber perform. The method can obtain uniform high quality of the porous optical fiber preform throughout the total length thereof, can minimize the process time, and can simply control a process.

In accordance with an aspect of the present invention, there is provided a method of dehydrating and consolidating a porous optical fiber preform in a heating apparatus, the heating apparatus comprising a muffle in which the porous optical fiber preform is placed and a plurality of multi-stage heaters attached to an outer circumference of the muffle in a longitudinal direction of the porous optical fiber preform. The method comprising the steps of: (a) placing the porous optical fiber preform in the muffle such that the multi-stage heaters surround a total length of the porous optical fiber preform; (b) heating and dehydrating the porous optical fiber preform in a state in which temperature of the multi-stage heaters reaches a dehydrating temperature of the porous optical fiber preform; (c-1) raising the temperature of one heater selected from the heaters to a consolidating temperature of the porous optical fiber preform; and (c-2) moving the dehydrated porous optical fiber preform, passing the dehydrated porous optical fiber preform through a high temperature zone formed by the selected heater in the muffle, and consolidating the dehydrated porous optical fiber preform.

### BRIEF DESCRIPTION OF THE DRAWINGS

The above advantages of the present invention will be more clearly understood from the following detailed description taken in conjunction with the accompanying drawings, in which:

FIG. 1 illustrates a conventional apparatus for dehydrating and consolidating a porous optical fiber preform;

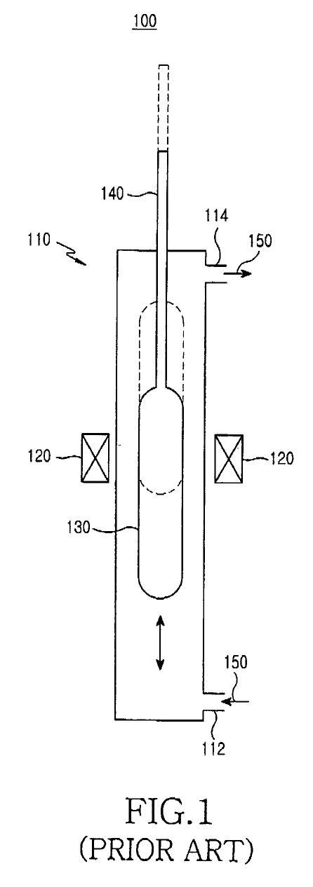

FIG. 2 illustrates an apparatus for dehydrating and consolidating a porous optical fiber preform in accordance with an embodiment of the present invention;

FIG. 3 is a flowchart illustrating a method for dehydrating and consolidating a porous optical fiber preform using the apparatus illustrated in FIG. 2; and

FIG. 4 is a graph illustrating an oxygen concentration distribution within a muffle illustrated in FIG. 2.

### DETAILED DESCRIPTION

For the purposes of clarity and simplicity, detailed descriptions of functions and configurations incorporated herein that are well known to those skilled in the art are omitted for clarity and conciseness.

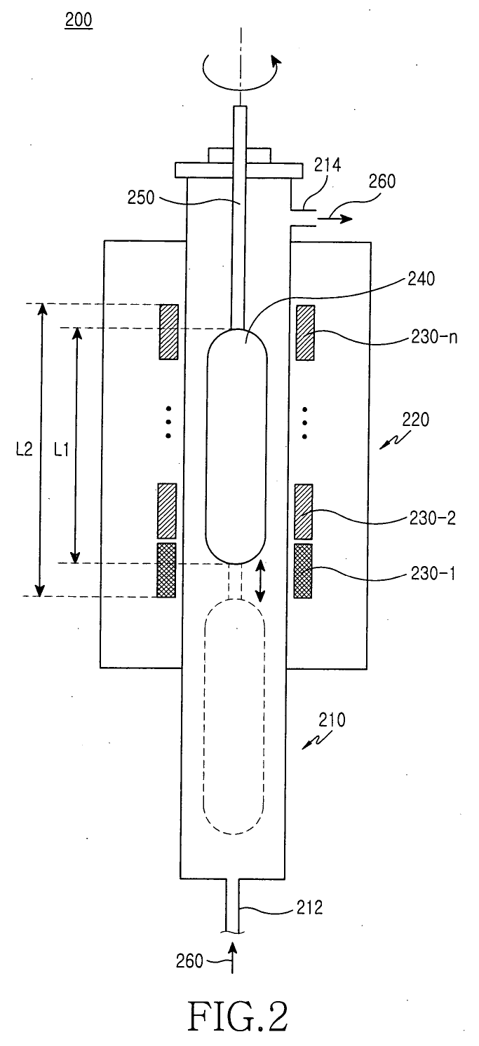

FIG. 2 illustrates an apparatus for dehydrating and consolidating a porous optical fiber preform in accordance with an embodiment of the present invention. The apparatus 200 is provided with a furnace 220 and a muffle 210.

A porous optical fiber preform 240 is supported by a handle rod 250 with a circular rod shape. An example of forming the porous optical fiber preform 240 according to a vapor axial deposition (VAD) process will be described. The porous optical fiber preform 240 can be vertically moved along a center axis in its longitudinal direction and can be rotated around the center axis.

A first burner (not shown) applies a flame in the center direction of the handle rod 250, such that a core layer of pure silica material is grown in a downward direction. Fuel and raw materials are supplied to the first burner. The core layer is deposited on an end of the handle rod 250 by the applied flame. The raw materials may be compounds such as SiCl₄, GeCl₄, POCl₃, and so on. A second burner (not shown) applies a flame to the outer surface of the core layer, such that a clad layer of a silica material is deposited which is doped with a material capable of controlling a refractive index. Fuel and raw materials are supplied to the second burner and the clad layer is deposited on the outer surface of the core layer by the applied flame.

The axis of the muffle 210 is coaxial with the center axis of the furnace 220. The muffle 210 is provided with a hole that is formed in the top of the muffle 210 and passes through the handle rod 250, an outlet tube 214 formed on the upper part of the side of the muffle 210, and an inlet tube 212 formed on the bottom of the muffle 210. Atmospheric gas 260 is supplied into the muffle 210 through the inlet tube 212. The atmospheric gas 260 is exhausted to the outside through the outlet tube 214. The porous optical fiber preform 240 is placed within the muffle 210.

The furnace 220 has a shape of a hollow cylinder and its center axis is coaxial with the axis of the muffle 210. The furnace 220 is provided with 1^{st} to n^{th} heaters 230-1 to 230-n of a multi-stage structure attached to an outer circumference of the muffle 210 in the longitudinal direction of the porous optical fiber preform 240. The 1^{st} heater 230-1 is placed in the lowest end, and the n^{th} heater 230-n is placed in the highest end. That is, the 1^{st} and n^{th} heaters 230-1 and 230-n are end heaters. The 1^{st} to n^{th} heaters 230-1 to 230-n are attached to the body of the furnace 220 in a ring shape. It is preferred that a total length L2 of the 1^{st} to n^{th} heaters 230-1 to 230-n in the longitudinal direction of the porous optical fiber preform 240 is at least longer than a length L1 of the porous optical fiber preform 240. The 2^{nd} to n^{th} heaters 230-2 to 230-n are low temperature heaters capable of raising heater temperature up to a dehydrating temperature (e.g., 1000˜1200° C.) of the porous optical fiber preform 240. The 1^{st} heater 230-1 is a high temperature heater capable of raising a heater temperature up to a consolidating temperature (e.g., 1500˜1600° C.) of the porous optical fiber preform 240. The 1^{st} to n^{th} heaters 230-1 to 230-n can be made of a material such as carbon or MoSi₂.

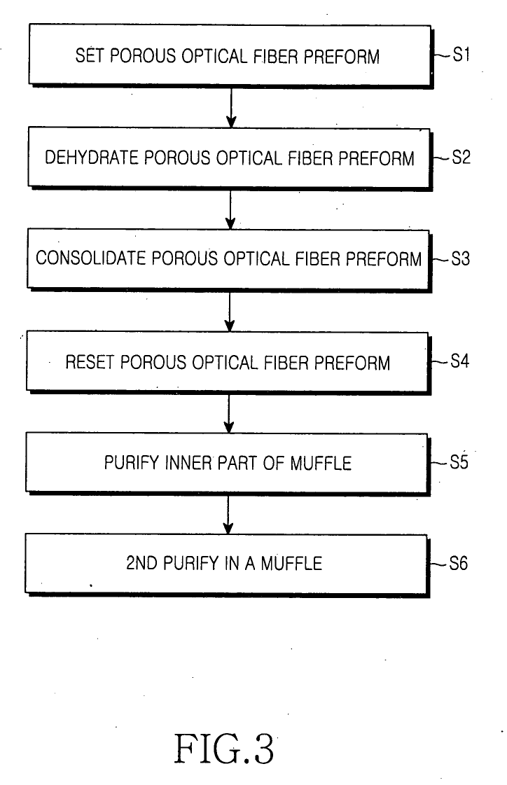

FIG. 3 is a flowchart illustrating a method for dehydrating and consolidating a porous optical fiber preform using the apparatus illustrated in FIG. 2. The method includes a setting process S1 for placing the porous optical fiber preform in the muffle, a dehydration process S2 for dehydrating the porous optical fiber preform, a consolidation process S3 for consolidating the porous optical fiber preform, a resetting process S4 for returning the porous optical fiber preform to the original position, and a purification process S5 for purifying the inner part of the muffle.

Hereinafter, a method of dehydrating and consolidating the porous optical fiber preform 240 in the apparatus 200 will be exemplarily described using concrete numerical values.

(a) In the setting process S1, the porous optical fiber preform 240 is placed in the muffle 210 such that it is totally surrounded by the 1^{st} to n^{th} heaters 230-1 to 230-n. The porous optical fiber preform 240 has a diameter of 165 mm and a length of 1200 mm, and the muffle 210 has a size of Major Diameter×Minor Diameter×Length, e.g., 215×200×2500 [mm]. The total length of the 1^{st} to n^{th} heaters 230-1 to 230-n is longer than that of the porous optical fiber preform 240. That is, the total length of the 1^{st} to n^{th} heaters 230-1 to 230-n is at least longer than 1200 mm.

(b) In the dehydration process S2, temperature of the 1^{st} to n^{th} heaters 230-1 to 230-n is raised to the dehydrating temperature of 1100° C. of the porous optical fiber preform 240. The porous optical fiber preform 240 is rotated at 1˜5 rpm. Cl₂ of 1.0 slpm serving as the atmospheric gas 260 is supplied into the muffle 210 through the inlet tube 212. The atmospheric gas 260 passes through the muffle 210 from the inlet tube 212, and is exhausted to the outside through the outlet tube 214. The time required for the dehydration process S2 is about 150 minutes.

(c) The consolidation process S3 is subdivided into two steps. First, temperature of the 1^{st} heater 230-1 is raised to the consolidating temperature of 1520° C. for the dehydrated porous optical fiber preform 240. At this time, temperature-raising rate is 10° C./min. Next, He of the atmospheric gas 260 is supplied into the muffle 210 through the inlet tube 212 when the temperature of the 1^{st} heater 230-1 reaches the consolidating temperature. The dehydrated porous optical fiber preform 240 is moved at a rate of 5.5 mm/min in the downward direction. The dehydrated porous optical fiber preform 240 is gradually consolidated from a lower end to an upper end thereof while passing through a high temperature zone of the muffle 210 formed by the 1^{st} heater 230-1. The consolidation process S3 is performed until the upper end of the dehydrated porous optical fiber preform 240 passes through the high temperature zone. That is, the consolidation process S3 is performed until the dehydrated porous optical fiber preform 240 is totally consolidated from the lower end to the upper end thereof.

(d) In the resetting process S4, the consolidated optical fiber preform 240 is moved to the original position (i.e., the position for the process (a)) in the upward direction. The resetting process is a process for preparing the next process, i.e., a process for dehydrating and consolidating another porous optical fiber preform. The resetting process S4 may be performed after the purification process S5 or may be omitted.

(e) In the purification process S5, the temperature of the 1^{st} heater 230-1 is lowered to an idle temperature of 1100° C. The atmospheric gas 260 is interrupted, and N₂ of 5 splm serving as purification gas is supplied into the muffle 210 through the inlet tube 212.

(f) When the purification process S5 is completed, the consolidated optical fiber preform is removed from the muffle 210.

In the method of dehydrating and consolidating a porous optical fiber preform in accordance with the present invention as described above, the porous optical fiber preform 240 is dehydrated by the 1^{st} to n^{th} heaters 230-1 to 230-n of the multi-stage structure without movement, and the dehydrated porous optical fiber preform 240 is heated by the 1^{st} heater 230-1 according to zone heating. Therefore, the method for dehydrating and consolidating the porous optical fiber preform has the following advantages.

First, the 1^{st} to n^{th} heaters 230-1 to 230-n of the multi-stage structure form a high temperature zone having a length equal to or more than that of the porous optical fiber preform 240 in the muffle 210. This method can significantly reduce the process time as compared with the zone heating method.

Second, the 1^{st} heater 230-1 heats the dehydrated porous optical fiber preform 240 according to the zone heating method in the consolidation process S3. The influence of uneven gas (e.g., nitrogen and oxygen incoming from the outside through the upper hole of the muffle 210) can be minimized which may be present in the upper part within the muffle 210.

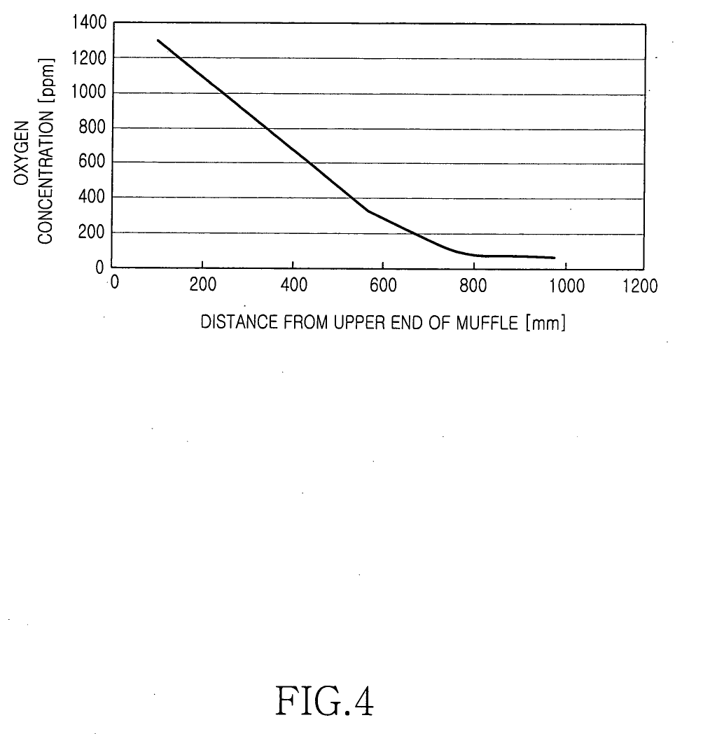

FIG. 4 is a graph illustrating an oxygen concentration distribution within the muffle 210. As shown, it can be found that the upper part within the muffle 210 includes a large amount of oxygen incoming from the outside through the upper hole of the muffle 210.

In accordance with the present invention, the dehydrated porous optical fiber preform 240 is heated according to the zone heating while being moved in the downward direction (i.e., from the upper part to the lower part in the muffle) in the consolidation process S3.

According to the above-described first and second advantages, the present invention can be applied to a large diameter porous optical fiber preform, and can obtain uniform high quality of the porous optical fiber preform throughout the total length thereof.

Third, the dehydration process S2 does not move the porous optical fiber preform and does not need complex temperature control protocol, such that it can simplify process control as compared with the prior art.

As is apparent from the above description, a porous optical fiber preform is dehydrated using multi-stage heaters and the dehydrated porous optical fiber preform is heated using one heater according to zone heating. Therefore, the present invention can be applied to a large diameter porous optical fiber preform, can obtain uniform high quality of the porous optical fiber preform throughout the total length thereof, can minimize the process time, and can simply control the process.

What is claimed is:

1. A method for dehydrating and consolidating a porous optical fiber preform in a heating apparatus comprising a muffle in which the porous optical fiber preform is placed and a plurality of multi-stage heaters coupled to an outer circumference of the muffle in a longitudinal direction of the porous optical fiber preform, the method comprising the steps of:
(a) placing the porous optical fiber preform in the muffle such that the multi-stage heaters surround a total length of the porous optical fiber preform;
(b) heating and dehydrating the porous optical fiber preform in a state in which a temperature of the multi-stage heaters reaches a dehydrating temperature of the porous optical fiber preform;
(c-1) raising a temperature of one heater selected from the heaters to a consolidating temperature of the porous optical fiber preform; and
(c-2) moving the dehydrated porous optical fiber preform, passing the dehydrated porous optical fiber preform through a high temperature zone formed by the selected heater in the muffle, and consolidating the dehydrated porous optical fiber preform.

2. The method of claim 1, wherein atmospheric gas is provided into the muffle during the steps (b) and (c-2).

3. The method of claim 1, further comprising the step of:
(d) moving the consolidated porous optical fiber preform to a position for the step (a).

4. The method of claim 1, further comprising the step of:
(e) providing purification gas into the muffle after the step (d) is completed.

5. The method of claim 1, wherein the selected heater is an end heater among the heaters.

6. The method of claim 5, wherein the end heater is a lowest end heater among the heaters, and wherein the dehydrated porous optical fiber preform is moved in a downward direction in the step (c-2).
